(19) United States
(12) Patent Application Publication
(10) Pub. No.: US 2018/0035285 A1
(43) Pub. Date: Feb. 1, 2018

(54) Semantic Privacy Enforcement

(71) Applicant: International Business Machines Corporation, Armonk, NY (US)

(72) Inventors: Pietro Ferrara, White Plains, NY (US); Marco Pistoia, Amawalk, NY (US); Omer Tripp, Yorktown Heights, NY (US)

(21) Appl. No.: 15/223,804

(22) Filed: Jul. 29, 2016

(51) Int. Cl. H04W 12/02; H04W 12/08

(52) U.S. Cl. CPC H04W 12/02; H04W 12/08

(57) ABSTRACT

Providing an online defense mechanism against privacy threats by storing a database of facts and an abstractions database in a storage medium. The database of facts includes a plurality of private data fields comprising at least a first set of private data fields and a second set of private data fields. The abstractions database associates at least one respective field of the first set of private data fields with at least one corresponding field of the second set of private data fields. A request is received from a mobile application for a first private data value from the first set of private data fields. The abstractions database and the database of facts are used to identify a second private data value from the second set of data fields that is associated with the first private data value. A response is formulated for the request by providing the second private data value.

### FIELD

The present application relates generally to mobile platforms and, more particularly, to techniques for addressing potential threats to privacy by obfuscating sensitive data while preserving data utility.

### BACKGROUND

The mobile era brings with it exciting possibilities to contextualize computations. Notable examples include location-based services, contextual recommendation and advertising systems, and social features. Modern mobile platforms, such as Android™ and iOS™, provide a wealth of contextual functionality. These mobile platforms have access to a user's current location, device identifier (ID), contact list, camera images, and recorded microphone clips. Thus, along with the opportunity for robust contextualization, various threats to a user's integrity and privacy may arise. These threats include unauthorized access to, and release of, sensitive user information. Examples of sensitive user information include, but are not limited to, names, geographic addresses, network identifiers, present geographic location, device IDs, social security numbers, medical information, login identifiers, passwords, and financial data. Likewise, malicious sending of premium short messaging service (SMS) messages on behalf of the user may occur. Phishing functionality may be cleverly disguised as a legitimate gaming, finance, or other application. Indeed, studies on malware and privacy threats have shown that many mobile applications defeat user expectations in terms of actions that these applications perform, as well as the manner in which these applications utilize user data.

Although the user is given the ability and responsibility to manage access-control rights, such as deciding whether or not to grant a given application access to the device ID, neither the application nor the platform provide any insight as to why the access is necessary, or how the accessed data will be manipulated. Indeed, the application may utilize sensitive data solely for non-essential purposes such as advertising, analytics, cross-application profiling, and social computing. Yet the core functionality of the application does not require the sensitive data. An illustrative example is an Android Flashlight™ application com.devuni.flashlight, which uses a camera flash on the mobile device as a source of illumination. Although the Android Flashlight™ application requires access to the Internet along with mobile device status, the screen illumination functionality could be implemented without accessing the Internet, and without accessing any user-specific information. However, the application may require mobile device-specific information related to a manufacturer and a model number in order to properly locate the camera flash on each of a plurality of different mobile devices.

Existing approaches for detecting and mitigating privacy threats track a flow of information starting at a privacy source and ending at a privacy sink. A privacy source is a statement reading a private piece of information, and a privacy sink is a statement that releases data to external observers. In Android™, an example of a privacy source is TelephonyManager.getDeviceId( ), which reads the device ID. Likewise, an example of a privacy sink is WebView.loadUrl( . . . ), which sends out a Hypertext Transfer Protocol (HTTP) request. Some illustrative examples of privacy detection and mitigation schemes include TaintDroid and BayesDroid.

Once an unsafe privacy source to privacy sink flow arises, the user is provided with a notification regarding the data arriving at the privacy sink and about to be released. The user is prompted to enter an indication into the mobile device specifying either an execution of the release operation, or a suppression of the release operation. The problem with this approach is threefold. First, suppressing the release operation often leads the application to crash, or at least transition into an unexpected and erroneous behavioral mode. Second, usability of the application is hindered by frequently popping up warning messages and asking the user to respond with a privacy judgment. Last, the user is often hardly in a position to analyze the context of the release operation and make an informed determination.

Recently, in response to some of the foregoing challenges, another privacy defense strategy has been developed whereby the release operation is not suppressed but the sensitive data is replaced or masked with random values. Some illustrative examples of this approach include AppFence and XPrivacy. The determination as to which items of data are sensitive can be based on a taint analysis approach. Taint analysis detects flows from sensitive data sources, such as location and phone state, to untrusted data sinks including data logs and the Internet. While having the potential to preserve more of the application's functionality, this approach has been reported by its designers to lead in many cases to crashes and incorrect application behaviors. Thus, there exists a need to overcome at least one of the preceding deficiencies and limitations of the related art.

### SUMMARY

The following summary is merely intended to be exemplary. The summary is not intended to limit the scope of the claims.

A method for providing an online defense mechanism against privacy threats, in one aspect, comprises storing a database of facts in a non-transitory computer-readable storage medium. The database of facts includes a plurality of private data fields each configured for storing private data values. The plurality of private data fields includes at least a first set of private data fields and a second set of private data fields. An abstractions database is stored in the non-transitory computer-readable storage medium. The abstractions database associates at least one respective field of the first set of private data fields with at least one corresponding field of the second set of private data fields. Each respective private data value in the first set of private data fields is associated with a corresponding private data value in the second set of private data fields. A request is received from a mobile application for a first private data value from the first set of private data fields. The abstractions database and the database of facts are used to identify a second private data value from the second set of data fields that is associated with the first private data value. A response to the request for the first private data value is formulated by providing the second private data value.

A method for providing an online defense mechanism against privacy threats, in a further aspect, comprises defining a logical model that specifies a respective format for each corresponding private data field of the plurality of private data fields. The mobile application is configured to specify a permitted level of access to one or more of the plurality of private data fields. In response to the mobile application accessing a first private data value from the first set of private data fields, the accessed first private data value is stored in a storage buffer. In response to a data release request, the storage buffer is scanned to identify one or more stored private data values from the first set of private data fields. In response to one or more stored private data values being identified, each of the one or more stored private data values are obfuscated with a corresponding private data value from the second set of private data fields based upon the abstractions database, the database of facts, and the logical model. Providing the corresponding private data value from the second set of private data fields preserves at least one functionality of the mobile application.

A computer program product for providing an online defense mechanism against privacy threats, in another aspect, comprises a non-transitory computer-readable storage medium having a computer-readable program stored therein, wherein the computer-readable program, when executed on a computer system comprising at least one processor, causes the computer system to store a database of facts in the non-transitory computer-readable storage medium. The database of facts includes a plurality of private data fields each configured for storing private data values. The plurality of private data fields includes at least a first set of private data fields and a second set of private data fields. An abstractions database is stored in the non-transitory computer-readable storage medium. The abstractions database associates at least one respective field of the first set of private data fields with at least one corresponding field of the second set of private data fields. Each respective private data value in the first set of private data fields is associated with a corresponding private data value in the second set of private data fields. A request is received from a mobile application for a first private data value from the first set of private data fields. The abstractions database and the database of facts are used to identify a second private data value from the second set of data fields that is associated with the first private data value. A response to the request for the first private data value is formulated by providing the second private data value.

A computer program product for providing an online defense mechanism against privacy threats, in a further aspect, comprises instructions for defining a logical model that specifies a respective format for each corresponding private data field of the plurality of private data fields. The mobile application is configured to specify a permitted level of access to one or more of the plurality of private data fields. In response to the mobile application accessing a first private data value from the first set of private data fields, the accessed first private data value is stored in a storage buffer. In response to a data release request, the storage buffer is scanned to identify one or more stored private data values from the first set of private data fields. In response to one or more stored private data values being identified, each of the one or more stored private data values are obfuscated with a corresponding private data value from the second set of private data fields based upon the abstractions database, the database of facts, and the logical model. Providing the corresponding private data value from the second set of private data fields preserves at least one functionality of the mobile application.

An apparatus for providing an online defense mechanism against privacy threats, in another aspect, may comprise a processor and a non-transitory computer-readable memory coupled to the processor, wherein the memory comprises instructions which, when executed by the processor, cause the processor to store a database of facts in the memory. The database of facts includes a plurality of private data fields each configured for storing private data values. The plurality of private data fields includes at least a first set of private data fields and a second set of private data fields. An abstractions database is stored in the non-transitory computer-readable storage medium. The abstractions database associates at least one respective field of the first set of private data fields with at least one corresponding field of the second set of private data fields. Each respective private data value in the first set of private data fields is associated with a corresponding private data value in the second set of private data fields. A request is received from a mobile application for a first private data value from the first set of private data fields. The abstractions database and the database of facts are used to identify a second private data value from the second set of data fields that is associated with the first private data value. A response to the request for the first private data value is formulated by providing the second private data value.

An apparatus for providing an online defense mechanism against privacy threats, in a further aspect, comprises instructions for defining a logical model that specifies a respective format for each corresponding private data field of the plurality of private data fields. The mobile application is configured to specify a permitted level of access to one or more of the plurality of private data fields. In response to the mobile application accessing a first private data value from the first set of private data fields, the accessed first private data value is stored in a storage buffer. In response to a data release request, the storage buffer is scanned to identify one or more stored private data values from the first set of private data fields. In response to one or more stored private data values being identified, each of the one or more stored private data values are obfuscated with a corresponding private data value from the second set of private data fields based upon the abstractions database, the database of facts, and the logical model. Providing the corresponding private data value from the second set of private data fields preserves at least one functionality of the mobile application.

### BRIEF DESCRIPTION OF THE SEVERAL VIEWS OF THE DRAWINGS

The foregoing aspects and other features are explained in the following description, taken in connection with the accompanying drawings, wherein:

FIG. 1 is a flowchart illustrating a first exemplary method for providing an online defense mechanism against privacy threats.

FIGS. 2A and 2B together comprise a flowchart illustrating a second exemplary method for providing an online defense mechanism against privacy threats.

FIG. 3 is a hardware block diagram of an exemplary computer or processing system that may implement any of the methods of FIGS. 1, 2A and 2B, in one set of embodiments of the present disclosure.

FIG. 4 is a data structure diagram of an exemplary database of facts for use with any of the methods of FIGS. 1, 2A, and 2B.

FIG. 5 is a data structure diagram of an exemplary abstractions database for use with any of the methods of FIGS. 1, 2A, and 2B.

### DETAILED DESCRIPTION

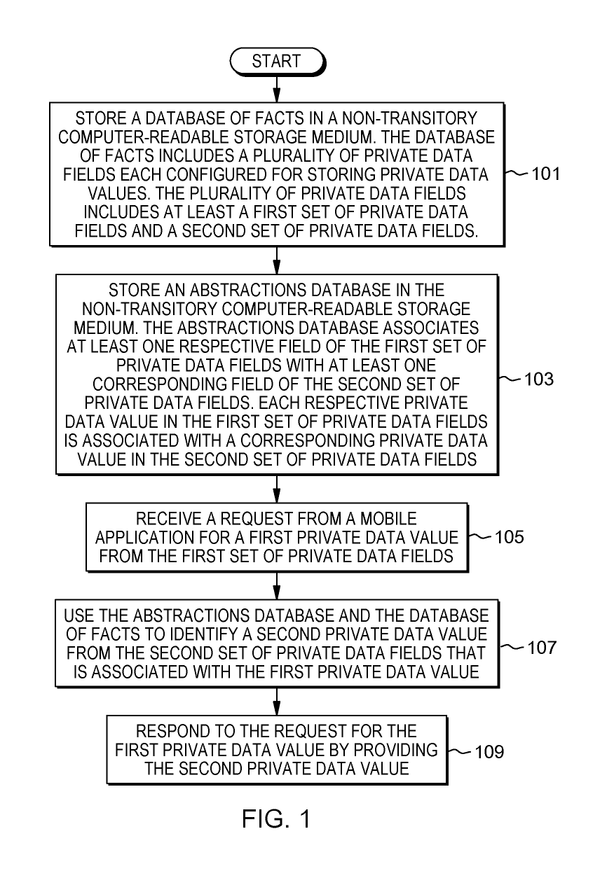

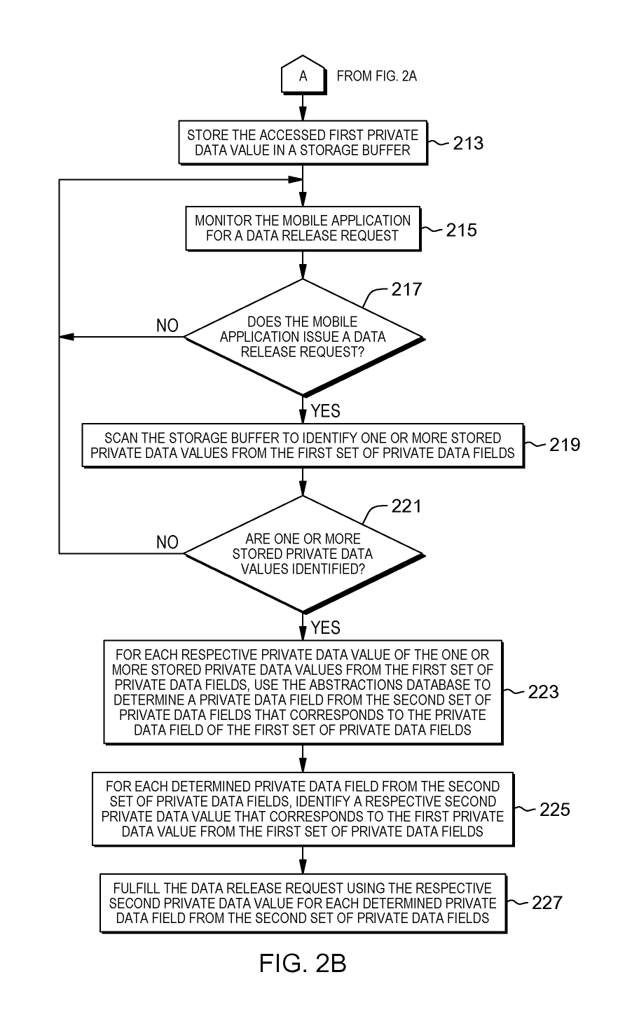

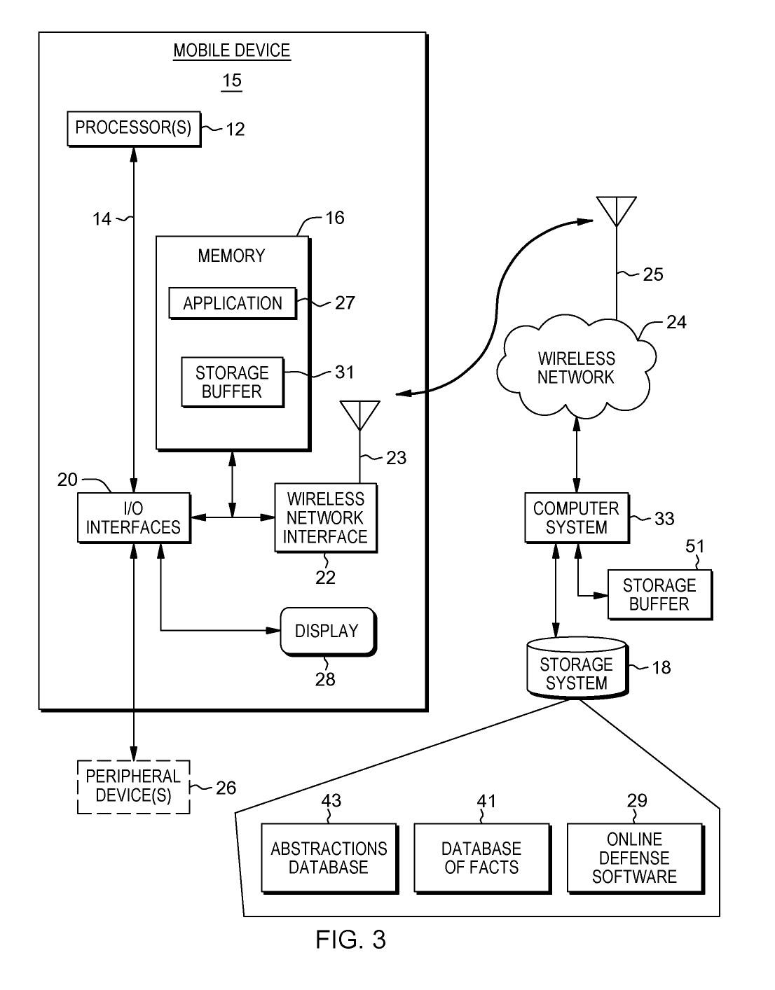

FIG. 1 is a flowchart illustrating a first exemplary method for providing an online defense mechanism against privacy threats. The procedure commences at block 101 where a database of facts 41 (FIGS. 3 and 4) is stored in a non-transitory computer-readable storage medium such as a storage system 18 (FIG. 3). The database of facts 41 (FIG. 4) includes a plurality of private data fields each configured for storing private data values. For example, the database of facts 41 may include a name 401 data field, a street address 403 data field, a city and state 405 data field, a zip code 407 data field, a current location 409 data field (illustratively comprising latitude and longitude), an age 411 data field, a birth date 413 data field, a device ID 415 data field, and a device type 417 data field.

The device ID 415 data field identifies a specific device, such as a smartphone, handheld computing device or tablet device, by serial number or International Mobile Station Equipment Identity (IMEI) number. The MEI is a number that is used to uniquely identify specific Third Generation Partnership Project (3GPP), Global System for Mobile (GSM), Universal Mobile Telephone System (UMTS), Long Term Evolution (LTE), and Integrated Digital Enhanced Network (iDEN) mobile phones, handheld devices, and tablets, as well as some satellite phones.

The plurality of private data fields includes at least a first set of private data fields and a second set of private data fields. For purposes of illustration, the first set of private data fields may comprise the current location 409 data field, the birth date 413 data field, and the device ID 415 field. Likewise, the second set of private data fields may comprise the street address 403 data field, the zip code 407 data field, the age 411 data field, and the device type 417 data field.

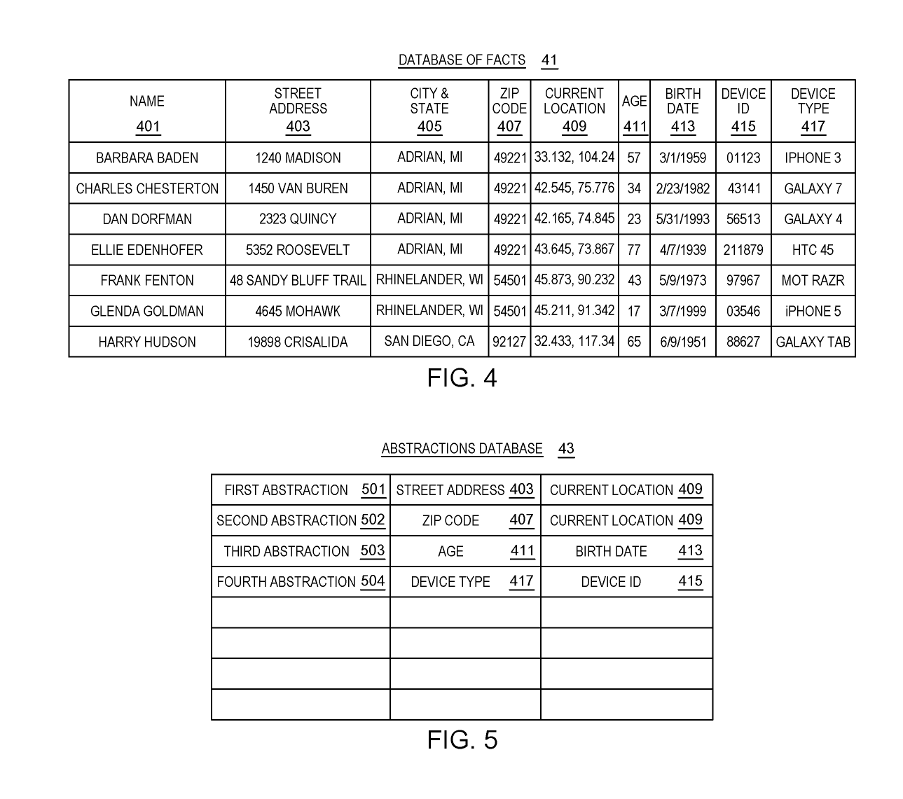

Next, the operational sequence of FIG. 1 progresses to block 103 where an abstractions database 43 (FIGS. 3 and 5) is stored in the non-transitory computer-readable storage medium. The abstractions database 43 associates at least one respective field of the first set of private data fields with at least one corresponding field of the second set of private data fields. Each respective private data value in the first set of private data fields is associated with a corresponding private data value in the second set of private data fields. For example, a first abstraction 501 (FIG. 5) associates the street address 403 data field with the current location 409 data field (FIGS. 4 and 5).

An abstraction may be regarded as the process of taking away or removing characteristics from something in order to reduce it to a set of essential or useful characteristics. Through the process of abstraction, a programmer is able to hide all but the relevant data about an object in order to reduce complexity and increase efficiency. Similar to the way in which abstraction is sometimes used in the field of art, the object that remains is a representation of the original, but with unwanted detail omitted. Thus, an object that is relatively complex and detailed can be abstracted to an object that is simpler, more general, and/or less detailed. The resulting object itself can be referred to as an abstraction, meaning a named entity made up of selected attributes and behavior specific to a particular usage of the originating entity.

For example, according to the first abstraction 501, a private value in the current location 409 data field is abstracted to a private value in the street address 403 data field. Similarly, according to the second abstraction 502, a private value in the current location 409 data field is abstracted to a private value in the zip code 407 data field. Likewise, according to the third abstraction 503, a private value in the birth date 413 data field is abstracted to a private value in the age 411 data field. Moreover, according to the fourth abstraction 504, a private value in the device ID 415 data field is abstracted to a private value in the device type 417 data field.

Abstracts (X, Y) means that a private value X abstracts a private value Y. In practice, the abstracts relation gives rise to a tree structure, whereby abstracted private values have exactly one parent. That is, abstracts (X, Y) AND abstracts (X, Z) implies that Y=Z. In the example of FIGS. 1, 4 and 5, to select appropriate values, the database of facts 41 is utilized. Assume that a user living in Adrian, Mich. at Zip Code 49221 does not wish to disclose his or her address to a mobile application. The procedure of FIG. 1 will result in the computer system 33 (FIG. 3) computing via available web application program interfaces (APIs) other addresses at the given zip code.

Pursuant to the technique of abstraction, an abstracted private value may have all of the relevant aspects included, without any of the extraneous aspects being present. A real-world analogy of abstraction operates as follows. Assume that an individual is arranging to meet a blind date and is deciding what to tell the date so that the date is able to recognize the individual at a prearranged rendezvous point such as a movie theater. The individual may decide to include information about where he or she will be located in the theater, as well as their height, hair color, and the color of their shirt. This information will facilitate the process of the date being able to quickly find the individual. On the other hand, there are a lot of bits of information about the individual that are irrelevant to this situation: his or her social security number, credit score, unique talent for repairing antique radios, and the name of their elementary school are all irrelevant to this particular situation because they would not help the date to find the individual. However, since an object may have any number of abstractions, the individual may be provided with an opportunity to use one or more of these currently irrelevant items in a future procedure for which the items may possess much greater relevance.

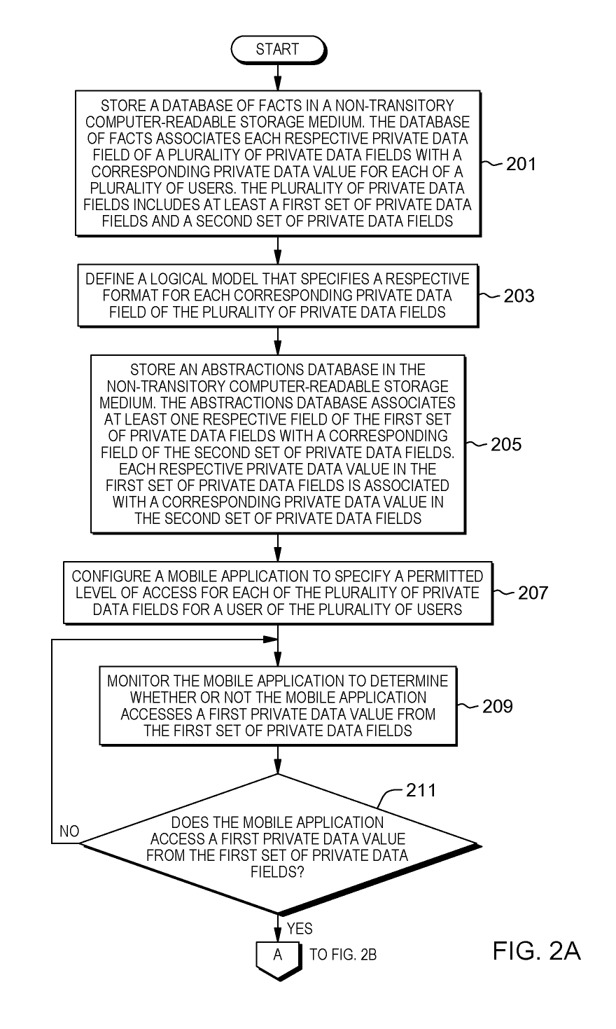

Optionally, the user may configure a level of access a mobile application 27 (FIG. 3) has to his or her private information. For example, if the mobile application 27 is a game, then it is often reasonable to not grant the application access to the user's precise location and/or device ID. This configuration step is described in greater detail with reference to FIGS. 2A and 2B.

Returning to FIG. 1, the operational sequence progresses to block 105 where a request is received from a mobile application 27 (FIG. 3) for a first private data value from the first set of private data fields. Next, at block 107 (FIG. 1), the abstractions database 43 (FIG. 5) and the database of facts 41 (FIG. 4) are used to identify a second private data value from the second set of data fields that is associated with the first private data value. At block 109 (FIG. 1), a response to the request for the first private data value is formulated by providing the second private data value.

FIGS. 2A and 2B together comprise a flowchart illustrating a second exemplary method for providing an online defense mechanism against privacy threats. The procedure commences at block 201 where the database of facts 41 (FIGS. 3 and 4) is stored in a non-transitory computer-readable storage medium such as a storage system 18 (FIG. 3). The database of facts 41 (FIG. 4) associates each respective private data field of a plurality of private data fields with a corresponding private data value for each of a plurality of users. As indicated previously, the plurality of private data fields includes at least a first set of private data fields and a second set of private data fields. For purposes of illustration, the first set of private data fields may comprise the current location 409 data field, the birth date 413 data field, and the device ID 415 field. Likewise, the second set of private data fields may comprise the street address 403 data field, the zip code 407 data field, the age 411 data field, and the device type 417 data field.

The operational sequence of FIGS. 2A and 2B progresses to block 203 (FIG. 2A) where a logical model is defined that specifies a respective format for each corresponding private data field of the plurality of private data fields. Next, at block 205, the abstractions database 43 (FIGS. 3 and 5) is stored in the non-transitory computer-readable storage medium. The abstractions database 43 associates at least one respective field of the first set of private data fields with at least one corresponding field of the second set of private data fields. Each respective private data value in the first set of private data fields is associated with a corresponding private data value in the second set of private data fields. Abstracts (X, Y) means that a private value X abstracts a private value Y. For example, a first abstraction 501 (FIG. 5) associates the street address 403 data field with the current location 409 data field (FIGS. 4 and 5). Thus, according to the first abstraction 501, a private value in the current location 409 data field is abstracted to a private value in the street address 403 data field. Similarly, according to the second abstraction 502, a private value in the current location 409 data field is abstracted to a private value in the zip code 407 data field. Likewise, according to the third abstraction 503, a private value in the birth date 413 data field is abstracted to a private value in the age 411 data field. Moreover, according to the fourth abstraction 504, a private value in the device ID 415 data field is abstracted to a private value in the device type 417 data field.

At block 207 (FIG. 2A), the mobile application 27 (FIG. 3) is configured to specify a permitted level of access for each of the plurality of private data fields for a user of the plurality of users. For example, if the mobile application 27 is a game, then it is often reasonable to not grant the application access to the user's precise location and/or device ID. Next, at block 209 (FIG. 2A), the mobile application is monitored to determine whether or not the mobile application accesses a first private data value from the first set of private data fields. At block 211, a test is performed to ascertain whether or not the mobile application accesses a first private data value from the first set of private data fields. If not, the program loops back to block 209. The affirmative branch from block 211 leads to block 213 (FIG. 2B) where the accessed first private data value is stored in a storage buffer 31 (FIG. 3) or a storage buffer 51 (FIG. 3).

The operational sequence progresses to block 215 (FIG. 2B) where the mobile application 27 (FIG. 3) is monitored for a data release request. At block 217 (FIG. 2B), a test is performed to ascertain whether or not the mobile application 27 (FIG. 3) issues a data release request. If not, the operational sequence loops back to block 215 (FIG. 2B). The affirmative branch from block 217 leads to block 219 where the storage buffer 31 (FIG. 3) or the storage buffer 51 (FIG. 3) are scanned to identify one or more stored private data values from the first set of private data fields. At block 221 (FIG. 2B), a test is performed to ascertain whether or not one or more stored private data values are identified. If not, the program loops back to block 215.

The affirmative branch from block 221 leads to block 223 where, for each respective private data value of the one or more stored private data values from the first set of private data fields, the abstractions database 43 (FIGS. 3 and 5) is used to determine a private data field from the second set of private data fields that corresponds to the private data field of the first set of private data fields. Then, at block 225 (FIG. 2B), for each determined private data field from the second set of private data fields, a respective second private data value is identified that corresponds to the first private data value from the first set of private data fields. The data release request is fulfilled using the respective second private data value for each determined private data field from the second set of private data fields.

Prior to a data release operation being performed as in block 227 (FIG. 2B), the storage buffer 31 (FIG. 3) or the storage buffer 51 (FIG. 3) is scanned at block 219 (FIG. 2B) to identify any private values that have been read by the mobile application 27. The scanning step of block 219 may be performed using any combination of precise matching and fuzzy matching. When fuzzy matching is used, the fuzziness may be provided along any of two dimensions. For example, similarity rather than equivalence-based matching may be applied using a string metric such as a Levenshtein methodology or a Hamming methodology. Second, the search is conducted not only for the original private value, but also for variants thereof, such as the user's birth date or address in any of a variety of different formats. Upon finding a match, data obfuscation is performed according to an abstraction in the abstractions database 43 (FIG. 5) and the pre-populated database of facts 41 (FIG. 4). This constitutes a computationally cheap replacement process where value-based matching is performed over source and sink endpoints without the need for full-fledged information flow tracking. Replacement of values for data obfuscation is performed according to known constraints and using the pre-populated database of facts 41. Accordingly, the procedures of FIGS. 1, 2A and 2B may be performed substantially in real time.

FIG. 3 illustrates a schematic of an exemplary mobile device 15 that may implement any of the methods of FIGS. 1, 2A, and 2B, in one set of embodiments of the present disclosure. The mobile device 15 is a portable computing device. Some illustrative examples of the mobile device 15 include a smartphone, a tablet computer, a cellphone, a personal digital assistant (PDA), a portable communications device, or a navigation system. The mobile device 15 is only one example of a suitable processing system and is not intended to suggest any limitation as to the scope of use or functionality of embodiments of the methodology described herein.

The mobile device 15 includes one or more processors 12 operatively coupled to a computer-readable memory 16. The memory 16 can include computer system readable media in the form of volatile memory, or non-volatile memory, or any of various combinations thereof. Some illustrative examples of volatile memory include random access memory (RAM) and/or cache memory, or other types of memory devices, or any of various combinations thereof. Some illustrative examples of non-volatile memory include read-only memory (ROM), magnetic media such as a “hard drive”, a solid-state storage drive, or an optical disk drive. The memory 16 includes an operating system (OS) that is executed by the one or more processors 12. Illustrative examples of operating systems include Andriod™ and Apple iOS™. The one or more processors 12 are configured to execute various types of software applications, sometimes referred to as apps. One example of an app is an application 27. The memory 16 also includes a storage buffer 31.

The one or more processors 12 may be described in the general context of computer system executable instructions, such as program modules, being executed by a computer system. Generally, program modules may include routines, programs, objects, components, logic, data structures, and so on that perform particular tasks or implement particular abstract data types. Thus, the one or more processors 12 may include a module that performs the methods described herein with reference to FIGS. 1, 2A and 2B. The module may be programmed into the integrated circuits of the one or more processors 12, or loaded from the memory 16, or the wireless network 24, or any of various combinations thereof.

The mobile device 15 may be operational with numerous other general purpose or special purpose computing system environments or configurations. Thus, the mobile device 15 includes a wireless network interface 22 coupled to a first antenna 23. The wireless network interface 22 and the first antenna 23 are configured for communicating with a wireless network 24 that is coupled to a second antenna 25. The wireless network 24 is operatively coupled to a computer system 33. The computer system 33 is equipped with a non-transitory computer readable memory such as a storage system 18. The storage system 18 is configured for storing the abstractions database 43, the database of facts 41, and an online defense software 29 program.

Illustratively, the wireless network interface 22 is configured for implementing wireless communication using a wireless standard such as Global System for Mobile Communications (GSM), Universal Mobile Telecommunications System (UMTS), Code Division Multiple Access (CDMA), Long-Term Evolution (LTE), 2G, 3G, 4G, 5G, Near Field Communications (NFC), WiFi, WiMAX, or Bluetooth. In general, these wireless standards are configured for efficiently dividing the finite RF spectrum among multiple users. For example, GSM uses time-division multiple access (TDMA) and frequency-division multiple access (FDMA) to provide separation among users and cells. UMTS and CDMA-2000 use code-division multiple access (CDMA). WiMAX and LTE use orthogonal frequency division multiplexing (OFDM). Illustratively, the mobile device 15 uses one or more of the foregoing wireless standards to access the Internet through the wireless network 24.

TDMA provides mobile device 15 access to the wireless network 24 by chopping up a physical RF communications channel occupying a given frequency bandwidth into sequential time slices. Each user of the channel takes turns to transmit and receive signals. In reality, only one mobile device 15 is actually using the channel at any specific moment in time. This is analogous to time-sharing on a large computer server. FDMA provides multiuser access by separating the frequencies used by each of a plurality of mobile devices such as the mobile device 15. In GSM, the FDMA approach is used to separate each of a plurality of cells of the wireless network 24, and then TDMA is used to separate each of a plurality of mobile device 15 users within the cell.

CDMA uses spread-spectrum digital modulation to spread voice data over a very wide channel in pseudorandom fashion using a mobile device 15-specific or cell-specific pseudorandom code. A receiver at the wireless network 24 undoes the randomization to collect the bits together and produce the original voice data. As the codes are pseudorandom and selected in such a way as to cause minimal interference to one another, multiple users can talk at the same time and multiple cells can share the same frequency. This causes an added signal noise forcing all users to use more power, which in exchange decreases cell range and battery life.

Orthogonal Frequency Division Multiple Access (OFDMA) uses bundling of multiple small frequency bands that are orthogonal to one another to provide for separation of mobile device 15 users. The users are multiplexed in the frequency domain by allocating specific sub-bands to individual users. This is often enhanced by also performing TDMA and changing the allocation periodically so that different users are assigned different sub-bands at different times. The foregoing wireless standards are provided solely for purposes of illustration, as the mobile device 15 may be configured for communicating with the wireless network 24 using any communications standard.

The mobile device 15 includes an input/output (I/O) interface 20. The I/O interface is used to interface the one or more processors 12 to the wireless network interface 22, a display 28, and one or more optional peripheral devices 26 such as a keyboard, a pointing device, or one or more devices that enable a user to interact with the mobile device 15. The display 28 may be provided in the form of a touch-sensitive screen and/or a miniature keyboard. The touch-sensitive screen may be configured to accept a tactile input or a stylus input, or both. The optional peripheral devices 26 may also include any device, such as a network card or a modem, that enables the mobile device 15 to communicate with one or more other computing devices. Such communication can occur via the I/O interface 20.

The computer system 33 may include a variety of computer system readable media. Such media may be any available media that is accessible by computer system, and it may include both volatile and non-volatile media, removable and non-removable media. In the example of FIG. 3, the computer system 33 is configured for accessing the storage system 18 and the storage buffer 51. The computer system 33 may be described in the general context of computer system executable instructions, such as program modules, being executed by a computer system. Generally, program modules may include routines, programs, objects, components, logic, data structures, and so on that perform particular tasks or implement particular abstract data types. Examples of well-known computing systems, environments, and/or configurations that may be suitable for implementing the computer system 33 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system 33 may be practiced in distributed cloud computing environments where tasks are performed by remote processing devices that are linked through a communications network such as the wireless network 24. In a distributed cloud computing environment, program modules may be located in both local and remote computer system storage media including memory storage devices such as the storage system 18.

The computer system 33 may further include other removable/non-removable, volatile/non-volatile computer system storage media. By way of example only, the storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided.

Both the mobile device 15 and the computer system 33 can communicate with one or more networks, such as the wireless network 24, a local area network (LAN), a general wide area network (WAN), and/or a public network (e.g., the Internet). It should be understood that although not shown, other hardware and/or software components could be used in conjunction with the computer system 33. Examples include, but are not limited to: microcode, device drivers, redundant processing units, external disk drive arrays, RAID systems, tape drives, and data archival storage systems, etc.

The mobile device 15 may be equipped with a source of battery power. Optionally, the mobile device 15 may also be equipped with a Global Positioning System (GPS) receiver for utilizing one or more location-based services. Other optional features of the mobile device 15 may include a camera, a media player for playing back video or music files, or one or more sensors. Such sensors may include an accelerometer, a compass, a magnetometer, or a gyroscope, allowing detection of orientation of motion. Optionally, the mobile device 15 may provide biometric user authentication, such as using a built-in camera for facial recognition or using a fingerprint sensor for fingerprint recognition.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for providing an online defense mechanism against privacy threats, the method comprising:
storing a database of facts in a non-transitory computer-readable storage medium, wherein the database of facts includes a plurality of private data fields each configured for storing private data values, and wherein the plurality of private data fields includes at least a first set of private data fields and a second set of private data fields;
storing an abstractions database in the non-transitory computer-readable storage medium, wherein the abstractions database associates at least one respective field of the first set of private data fields with at least one corresponding field of the second set of private data fields, and wherein each respective private data value in the first set of private data fields is associated with a corresponding private data value in the second set of private data fields;
receiving a request from a mobile application for a first private data value from the first set of private data fields;
using the abstractions database and the database of facts to identify a second private data value from the second set of data fields that is associated with the first private data value; and
formulating a response to the request for the first private data value by providing the second private data value.

2. The method of claim 1 further comprising defining a logical model that specifies a respective format for each corresponding private data field of the plurality of private data fields.

3. The method of claim 1 further comprising configuring the mobile application to specify a permitted level of access to one or more of the plurality of private data fields.

4. The method of claim 1 further comprising, in response to the mobile application accessing a first private data value from the first set of private data fields, storing the accessed first private data value in a storage buffer.

5. The method of claim 1 further comprising, in response to a data release request, scanning the storage buffer to identify one or more stored private data values from the first set of private data fields.

6. The method of claim 1 further comprising, in response to one or more stored private data values being identified, obfuscating each of the one or more stored private data values with a corresponding private data value from the second set of private data fields based upon the abstractions database, the database of facts, and the logical model.

7. The method of claim 1 further comprising providing the corresponding private data value from the second set of private data fields to preserve at least one functionality of the mobile application.

8. An apparatus for providing an online defense mechanism against privacy threats, the apparatus comprising a processor and a non-transitory computer-readable memory coupled to the processor, wherein the memory comprises instructions which, when executed by the processor, cause the processor to perform:
storing a database of facts in a non-transitory computer-readable storage medium, wherein the database of facts includes a plurality of private data fields each configured for storing private data values, and wherein the plurality of private data fields includes at least a first set of private data fields and a second set of private data fields;
storing an abstractions database in the non-transitory computer-readable storage medium, wherein the abstractions database associates at least one respective field of the first set of private data fields with at least one corresponding field of the second set of private data fields, and wherein each respective private data value in the first set of private data fields is associated with a corresponding private data value in the second set of private data fields;
receiving a request from a mobile application for a first private data value from the first set of private data fields;
using the abstractions database and the database of facts to identify a second private data value from the second set of data fields that is associated with the first private data value; and
formulating a response to the request for the first private data value by providing the second private data value.

9. The apparatus of claim 8 further comprising instructions for defining a logical model that specifies a respective format for each corresponding private data field of the plurality of private data fields.

10. The apparatus of claim 8 further comprising instructions for configuring the mobile application to specify a permitted level of access to one or more of the plurality of private data fields.

11. The apparatus of claim 8 further comprising instructions for storing the accessed first private data value in a storage buffer in response to the mobile application accessing a first private data value from the first set of private data fields.

12. The apparatus of claim 8 further comprising instructions for scanning the storage buffer to identify one or more stored private data values from the first set of private data fields in response to a data release request.

13. The apparatus of claim 8 further comprising instructions for obfuscating each of the one or more stored private data values with a corresponding private data value from the second set of private data fields based upon the abstractions database, the database of facts, and the logical model, in response to one or more stored private data values being identified.

14. The apparatus of claim 8 further comprising instructions for providing the corresponding private data value from the second set of private data fields to preserve at least one functionality of the mobile application.

15. A computer program product for providing an online defense mechanism against privacy threats, the computer program product comprising a computer-readable storage medium having a computer-readable program stored therein, wherein the computer-readable program, when executed on a computer system comprising at least one processor, causes the processor to perform:
storing a database of facts in a non-transitory computer-readable storage medium, wherein the database of facts includes a plurality of private data fields each configured for storing private data values, and wherein the plurality of private data fields includes at least a first set of private data fields and a second set of private data fields;
storing an abstractions database in the non-transitory computer-readable storage medium, wherein the abstractions database associates at least one respective field of the first set of private data fields with at least one corresponding field of the second set of private data fields, and wherein each respective private data value in the first set of private data fields is associated with a corresponding private data value in the second set of private data fields;
receiving a request from a mobile application for a first private data value from the first set of private data fields;
using the abstractions database and the database of facts to identify a second private data value from the second set of data fields that is associated with the first private data value; and
formulating a response to the request for the first private data value by providing the second private data value.

16. The computer program product of claim 15 further comprising instructions for defining a logical model that specifies a respective format for each corresponding private data field of the plurality of private data fields.

17. The computer program product of claim 15 further comprising instructions for configuring the mobile application to specify a permitted level of access to one or more of the plurality of private data fields.

18. The computer program product of claim 15 further comprising instructions for storing the accessed first private data value in a storage buffer in response to the mobile application accessing a first private data value from the first set of private data fields.

19. The computer program product of claim 15 further comprising instructions for scanning the storage buffer to identify one or more stored private data values from the first set of private data fields in response to a data release request.

20. The computer program product of claim 15 further comprising instructions for obfuscating each of the one or more stored private data values with a corresponding private data value from the second set of private data fields based upon the abstractions database, the database of facts, and the logical model, in response to one or more stored private data values being identified.
